(19) United States
(12) Patent Application Publication
(10) Pub. No.: US 2024/0337995 A1
(43) Pub. Date: Oct. 10, 2024

(54) AUTOMATION SYSTEM FOR ASSET MANAGEMENT AND MAINTENANCE, BUILDING MANAGEMENT AND ENERGY MANAGEMENT

(71) Applicants: Juan Manuel CORREA MARÍN, BOGOTA (CO); COMERCIALIZADORA BECOR S A, BOGOTA (CO)

(72) Inventor: Juan Manuel CORREA MARÍN, BOGOTA (CO)

(21) Appl. No.: 18/293,624

(22) PCT Filed: Mar. 12, 2022
(86) PCT No.: PCT/IB2022/052233

§ 371 Date: Jan. 30, 2024

(30) Foreign Application Priority Data
Jul. 30, 2021 (CO) NC2021/0010185

(51) Int. Cl. G05B 15/02

(52) U.S. Cl. CPC G05B 15/02

(57) ABSTRACT

The present invention pertains to an automation system for asset and maintenance management, building management, and energy management, comprising four interconnected modules. The first module functions as a monitoring, management, and control module for devices; the second module serves as an artificial intelligence module; the third module operates as an energy efficiency module, and the fourth module functions as an asset and maintenance management module.

### TECHNICAL FIELD

The present invention pertains to the Internet of Things (IoT), computerized asset and maintenance management systems (CMMS/EAM), building management systems (BMS), and energy management systems (EMS) integrated with artificial intelligence tools.

### BACKGROUND OF THE INVENTION

Computer systems that monitor, manage, control, supervise, automate, and analyze information from mechanical, electronic, and electrical elements or equipment in industrial and service sectors are typically standalone solutions. An example of such a solution is described in US Patent U.S. Pat. No. 10,248,091 B2, which outlines a method and apparatus for providing equipment maintenance—essentially a single, independent solution. This method receives data captured by at least one sensor deployed in a location, associates the data with at least one equipment parameter, determines the need for an update of a risk measure associated with the equipment, and, upon detecting a deviation from a baseline greater than a threshold, updates the risk measure. When an update is needed, a ticket is generated for corrective action based on the risk measure, triggering the scheduling of the corrective action. However, this invention is specifically focused on equipment maintenance management and does not integrate asset management, building management, artificial intelligence, or energy management, as the present invention does.

Furthermore, US Patent US20160028605A1 presents certain systems and methods directed towards access features and/or improvement of the efficiency of the building system. While it includes aspects such as measuring occupant comfort, conserving energy in linear heating and cooling asset networks, and improving machine efficiency by increasing maintenance effectiveness, it is entirely focused on the energy management of heating equipment. There is no mention of integrating this management with other systems, such as equipment maintenance management, asset management, building management, or artificial intelligence.

Additionally, the invention presented in CN109343426A describes a method for detecting sensors in the Internet of Things-based public service system of an aircraft. This invention addresses issues related to sensor detection in aircraft but is solely focused on aircraft detection and lacks references to asset and maintenance management, building management, or energy management within a unified platform.

On another note, document CN108900997B introduces a method for detecting a chain of industrial process equipment using a distributed wireless sensor network. While it focuses on wireless detection, industrial process equipment failure prediction, and self-leaning expert base, it does not refer to the management of other disciplines, such as asset management, building management, or artificial intelligence, which are integral components of the present invention.

US Patent U.S. Pat. No. 9,557,750B2 introduces a control system for operating HVAC systems within a building to control environmental conditions. This invention mentions building management with regard to HVAC system monitoring but does not involve the management and monitoring of other processes or devices, which is a key aspect of the present invention.

JP2016163242A aims to reduce the load on a network or a computer on the central installation side, making data size variable, focusing on data acquisition, analysis, and action through a gateway. However, it does not integrate multiple disciplines into a single platform for managing various processes and equipment involved in different industries.

Lastly, US Patent US20150142991A1 refers to an electronic hub device used to collect, store, and process potentially massive periodic data flows indicative of real-time measurement parameters or other data. It particularly focuses on real-time data analysis based on different parameters but does not take action on any device or process.

In conclusion, although there are documents that present the capture, analysis, and action on a device or process, each of these is directed towards different objects and processes. None of them integrates the capture, analysis, and action in the four disciplines of the present invention: asset and maintenance management, building management, energy management, and artificial intelligence. This integration represents a significant advancement in the technological sector, and its characteristics do not correspond to the sum or combination of one or more of the cited documents.

### DESCRIPTION OF THE INVENTION

The present invention aims to integrate into a single digital platform an automation system that combines asset and maintenance management, building management, energy management, and artificial intelligence. This integration allows for the correlation and seamless integration of these disciplines, facilitating the development of a computer system that easily adapts to the needs of any industrial or service sector company for taking actions on its equipment and processes through a Gateway.

Specifically, the present invention introduces an automation system for asset and maintenance management, building management, and energy management, comprising the following four modules: a monitoring, management, and control module for devices, an asset and maintenance management module, an energy efficiency module, and an artificial intelligence module.

The monitoring, management, and control module for devices collect information from the sensor network through a Gateway, which receives information from sensors either wired or wirelessly and automated actions sent from the platform for device activation or deactivation. This module also stores, organizes, and classifies sensor information, sending it to any of the following modules: asset management module, energy efficiency module, and/or artificial intelligence module.

The asset and maintenance management module associates the collected data with the related asset. On the other hand, the energy efficiency module associates and monitors the received data from each related asset. The artificial intelligence module automates information from other modules, analyzes data, and sends actions to each module and the gateway for device activation or deactivation. This artificial intelligence module receives information from the monitoring, management, and control module for devices and, based on it, detects anomalies, predicts behaviors, formulates new variables, and automates information, instructing the gateway to activate or deactivate devices. This artificial intelligence module receives information from the asset and maintenance management module with the definition of maintenance plans and triggers the execution of work orders. It also receives information from the energy efficiency module with details on non-conformities and operational controls, energy performance indicators, baselines, and the establishment and monitoring of savings goals, subsequently triggering operational controls, resolution of non-confornities, and the execution of work orders.

In a particular embodiment, the artificial intelligence module comprises a processor that can be basic or advanced. The basic analytics processor includes a first component called mathematical formulas that receives information from different equipment and generates analysis variables or indicators. A second component called automation uses the indicators generated in the mathematical formulas, the results of advanced analytics, information collected from the sensor network, information from the asset and maintenance management module, and information from the energy management module to create a series of conditions. Once evaluated, these conditions allow the execution of automatic rules such as activating or deactivating equipment, executing condition-based maintenance plans, resolving non-conformities, performing operational controls, and generating alarms or dynamic alerts correlated with one or more variables.

The advanced analytics processor, with the use of artificial intelligence, includes a first component for data analysis through graphs. Based on information collected from different equipment, it generates graphs for comparative analysis, correlation, trend analysis, alarm analysis, average analysis, and detection of historical anomalies. The second component, utilizing historical data and artificial intelligence techniques, uses models representing the behavior of analyzed variables to predict future behavior, detect real-time anomalies, analyze averages based on behavior by time of day or day of the week, analyze correlations with the analyzed variable, trends and histograms, and activate the automation process. A third component, the action module, receives the results of the analyses performed in the advanced analytics processor and creates improvement and future failure prevention projects. Each project can define objectives, duration, director, stakeholders, and project activities. It generates baseline behavior for historical and current variable data, establishes Key Performance Indicators (KPIs) for equipment behavior concerning historical behavior and predictions, and establishes operational controls or activities executed as part of a project or triggered by automation.

The asset and maintenance management module includes the management of maintenance plans, visualization of KPIs, report and report management, work order management, and asset management administration at different locations. Maintenance is established for each asset, associated with preventive maintenance, corrective maintenance, and/or condition-based maintenance. Preventive maintenance has a scheduled execution, corrective maintenance is performed upon request due to detected process failures, and condition-based maintenance is based on the parameterization done in the automation module that each variable or group of variables can activate based on a rule for plan execution.

Work orders are generated based on the scheduling of maintenance plans, where authorized personnel must assign tasks to in-house or third-party personnel for execution. Operational staff receives the work order with assigned tasks through the platform's messaging service or via email. Once tasks are completed, they are automatically sent to authorized personnel for approval or disapproval.

The visualization of KPIs and reports is generated based on information collected from assets and generated work orders. The system automatically calculates the following performance indcators: Total Availability, Reliability (Availability due to failures), Mean Time Between Failures (MTBF), and Mean Time to Repair (MTTR). These indicators can be viewed by asset, related asset group, or site. Additionally, the system automatically performs the following analyses' Task analysis, failure analysis, and work order analysis. These can be viewed by asset, related asset group, site, or by the user responsible for the asset or task execution.

Asset administration (infrastructure, equipment, etc.) at different locations is carried out by organizing a hierarchical structure to easily locate any asset within the hierarchy. All assets included below it can affect its KPIs.

The energy management module allows for recording and monitoring an Energy Management System (EMS) based on ISO 50001. Through knowledge of the business and measurements of consumption, Significant Energy Uses (SEUs) can be established and recorded, related in a productive energy diagram through a Sankey diagram. This allows visualizing the uses and types of energy used in processes. Energy efficiency projects aimed at reducing energy consumption can be created and applied to one or several SEUs, with established savings goals. In each project, a Baseline can be automatically established for comparison against a monitoring period to evaluate SEU performance through standard or user-created Energy Performance Indicators (EPIs). Operational controls can be created to be executed within one or several projects, verified periodically to improve the energy performance of SEUs.

### BRIEF DESCRIPTION OF THE FIGURES

FIG. 1. Monitoring, Management, and Control Module for Devices.

FIG. 2. Artificial Intelligence Module.

FIG. 3. Energy Efficiency Module.

FIG. 4. Asset and Maintenance Management Module.

### DETAILED DESCRIPTION OF THE INVENTION

The present invention relates to an automation system for asset and maintenance management, building management, and energy management, comprising four interconnected modules: a first module, which is the device monitoring, management, and control module (100); a second module, an artificial intelligence module (200); a third module, an energy efficiency module (300); and a fourth module, an asset and maintenance management module (400).

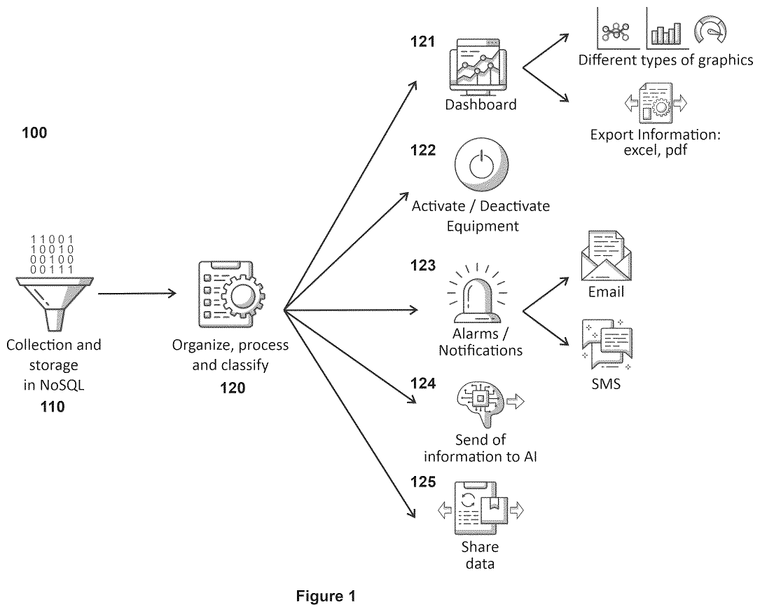

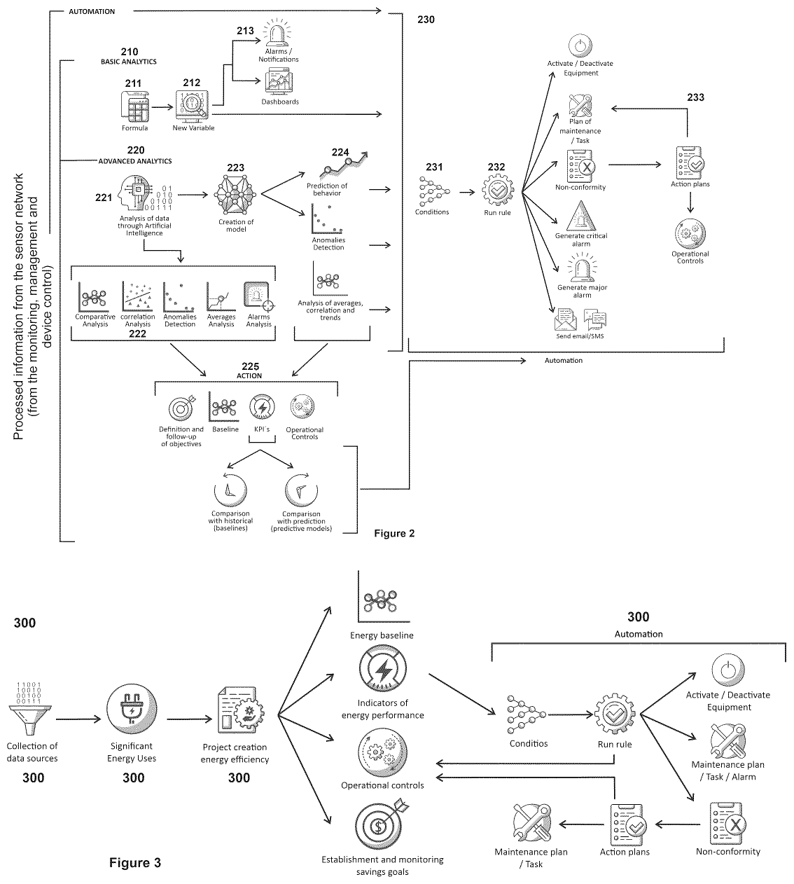

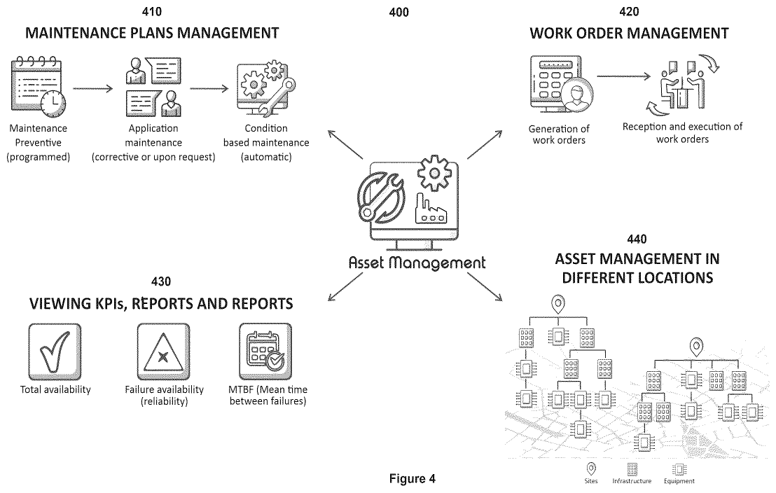

The module in FIG. 1, the device monitoring, management, and control module (100), collects and stores information in NoSQL (110), which is later organized, processed, and classified (120) in a database. Once the processed information is available, it can be used to visualize data using configurable widgets and dashboards (121), turn devices on or off (122) through the gateway, generate alarms and notifications via email and SMS (123) based on the collected data, send information to the Artificial Intelligence module (124) for processing, and share data (125) with the asset and maintenance management modules and the energy efficiency module.

The processed information from the sensor network in FIG. 1 is received by the artificial intelligence module in FIG. 2, which includes a basic analytics module (210), advanced analytics module (220), action module (225), and automation module (230).

The basic analytics module (210) creates formulas and performs mathematical operations (211) from which it generates a new analysis variable or indicator (212) to be visualized in configurable widgets and dashboards or to trigger alarms and notifications (213). Finally, this information is integrated with the automation module (230).

The advanced analytics module (220) analyzes historical variables using artificial intelligence (221), which includes a comparative graphical analysis tool between variables, correlation analysis, alarm analysis, average analysis, and anomaly detection (222). It also involves the creation of models (223) to detect anomalies in real-time, predict behavior, analyze averages, correlation, and trends (224), and an action module (225) that allows users to create improvement projects based on the results of the analyses done in the graphical analysis tool and the creation of models. It further allows the creation of projects with objectives, timelines, directors, stakeholders, and activities, as well as the generation of baselines, establishment of KPIs, and operational controls.

Automation Module (230) includes creating a series of conditions (231) and evaluating the conditions to determine the execution of the following rules: Activating or deactivating equipment, executing specific tasks or condition-based maintenance plans, generating a non-conformity, generating a critical or major alarm, and sending notifications (232). As a result of the non-conformity, an action plan is generated that executes operational controls related to the energy efficiency module and the Action tool or condition-based maintenance plans (233).

The Energy Efficiency Module (300) collects data from sensors or processed information from the device monitoring, management, and control module (310). It then establishes and records Significant Energy Uses (320), which include: Relating Energy Uses in a Sankey diagram; visualizing the types and uses of energy used; and defining the relationship between the uses and types of energy used by processes and defining energy projects (330) for one or more of the Significant Energy Uses. Within each energy project, the following are defined: Efficiency objectives; execution times; and work teams and activities to be carried out. Within each energy project, baselines, performance indicators, operational controls, and the establishment and monitoring of savings goals are set. Depending on the performance indicator results, information is sent to the automation module (340).

The Asset and Maintenance Management Module (400) receives processed information from the device monitoring, management, and control module. It associates the information with the corresponding asset, digitizes information about physical assets, manages Maintenance Plans (410), manages work orders (420), visualizes KPIs, and analyzes tasks (430). It also administers assets (440).

Specifically, the Management of Maintenance Plans includes Preventive Maintenance Plans, Predictive Maintenance Plans, and Condition-Based Maintenance Plans; the Management of work orders includes receiving the work order, assigning personnel for execution, receiving them with the tasks performed for approval or disapproval; KPI Visualization includes automatically calculating KPIs by asset, by related group of assets, or by site. The Analysis of tasks, failures, and work orders involves analyzing assets or sites. Finally, the administration of assets is carried out in different locations.

While the above detailed description describes some examples of the technology and describes the best anticipated way, no matter how detailed the foregoing may appear in the text, the technology can be practiced in many ways.

Details may vary in implementation while still falling within the scope of the technology described in this document. As noted earlier, the particular terminology used to describe certain features or aspects of the technology is not limited to any specific features or aspects associated with that terminology. In general, the terms used in the following claims should not be construed to limit the technology to the specific examples described herein. Accordingly, the scope of the technology encompasses not only the described examples but also all equivalent forms of practicing or implementing the technology.

The invention claimed is:

1) An automation system for asset and maintenance management, building management, and energy management comprising four interconnected modules, wherein; the first module is a monitoring, management, and control module for devices; the second module is an artificial intelligence module; the third is an energy efficiency module; and, the fourth module is an asset and maintenance management module.

2) The system for asset and maintenance management, building management, and energy management of claim 1 comprises a monitoring, management, and control module for devices that has stored instructions wherein, when executed, cause the system to perform operations comprising:
collecting information from sensors and storing this data in a NoSQL database;
organizing, processing, and classifying the information;
visualizing the data using configurable widgets and dashboards;
turning devices on or off through the gateway;
generating alarms based on the collected data;
sending information to the artificial intelligence module for processing; and,
sharing data with the asset and maintenance management modules and the energy efficiency module.

3) The system for asset and maintenance management, building management, and energy management of claim 1 comprises an artificial intelligence module that includes a basic analytics module and an advanced analytics module.

4) The system for asset and maintenance management, building management, and energy management of claim 3 comprises an artificial intelligence module that has stored instructions wherein, when executed, cause the system to perform operations comprising:
basic analytics;
advanced analytics;
automation.

5) The system for asset and maintenance management, building management, and energy management of claim 4 comprises the artificial intelligence module that has basic analytics with stored instructions wherein, when executed, cause the system to perform operations comprising:
receiving processed information from the monitoring, management, and control module for devices;
creating formulas and performing mathematical operations with different variables;
creating a new analysis variable or indicator, to which a name is assigned and stored in a database;
generating alarms and sending emails and SMS;
visualizing the new variable in widgets and configurable dashboards in the monitoring, management, and control module for devices; and,
integrating information into the automation module.

6) The system for asset and maintenance management, building management, and energy management of claim 4 comprises the artificial intelligence module that has advanced analytics with stored instructions wherein, when executed, cause the system to perform operations comprising:
receiving processed information from the monitoring, management, and control module for devices;
analyzing historical data of variables;
creating analytics models representing the behavior of a variable;
creating improvement and prevention projects for future failures from the action module.

7) The system for asset and maintenance management, building management, and energy management of claim 6 comprises the artificial intelligence module where the analysis of historical data of variables includes a comparative graphical analysis tool between variables, correlation analysis, alarm analysis, average analysis, and anomaly detection.

8) The system for asset and maintenance management, building management, and energy management of claim 6, wherein the analytics models of the artificial intelligence module comprises:
real-time anomaly detection;
predicting behavior;
analyzing averages, correlation, and trends;
integrating anomaly detection and predictions into the automation module.

9) The system for asset and maintenance management, building management, and energy management of claim 6 comprises the action module of advanced analytics of the artificial intelligence module where the module:
creates the project including
I. objectives,
II. time,
III. director, stakeholders, and activities;
generates baselines, representing the historical and current behavior of a variable;
establishes KPIs, representing how the behavior of equipment or a variable is changing conceming historical behavior and prediction, comprising
I. comparison of historical data,
II. comparison of predictions;
creates operational controls.

10) The system for asset and maintenance management, building management, and energy management of claim 4 comprises an artificial intelligence module where automation has stored instructions that, when executed, cause the system to perform operations comprising:
receiving processed information from the monitoring, management, and control module for devices or from the artificial intelligence module or the energy management module;
creating a series of conditions between two or more variables;
evaluating the conditions and determining the execution of the following rules, activating or deactivating equipment, executing specific tasks or condition-based maintenance plans, generating a non-conformity, generating critical or major alarms, and sending notifications.

11) The system for asset and maintenance management, building management, and energy management of claim 1 comprises a device energy efficiency module that has stored instructions wherein, when executed, cause the system to perform operations comprising:
receiving processed information from the monitoring, management, and control module for devices;
establishing and recording significant energy uses;
defining an energy project for one or more of the significant energy uses, which includes
I. relating the energy uses in a Sankey diagram,
II. visualizing the types and uses of energy employed,
III. defining the relationship between the uses and types of energy used by processes;
defining an energy project for one or more significant energy uses, comprising
i. efficiency objectives,
ii. execution times,
iii. work team and activities to be executed.

12) The system for asset and maintenance management, building management, and energy management of claim 11 comprises the definition of the energy project that includes establishing an energy baseline that sets a model representing the behavior of energy use.

13) The system for asset and maintenance management, building management, and energy management of claim 11, wherein the definition of the energy project includes establishing energy performance indicators and determining the project's progress in terms of efficiency and effectiveness.

14) The system for asset and maintenance management, building management, and energy management of claim 11, wherein the definition of the energy project includes sending the indicator results to the artificial intelligence module for evaluation and action.

15) The system for asset and maintenance management, building management, and energy management of claim 11, wherein the definition of the energy project includes operational controls or specific actions executed on an asset to improve the performance of significant energy uses.

16) The system for asset and maintenance management, building management, and energy management of claim 11, wherein the definition of the energy project includes establishing and monitoring savings goals that comprise measuring and verifying the values received in the monitoring, management, and control module versus the baseline and savings goal.

17) The system for asset and maintenance management, building management, and energy management of claim 1 comprises an asset and maintenance management module that has stored instructions wherein, when executed, cause the system to perform operations comprising:
receiving processed information from the monitoring, management, and control module for devices;
associating it with the corresponding asset digitizing information from physical assets;
managing maintenance plans;
managing work orders;
visualizing KPIs;
analyzing tasks; and
administering assets.

18) The system for asset and maintenance management, building management, and energy management of claim 17, wherein the management of maintenance plans comprises preventive maintenance plans, corrective maintenance plans, and condition-based maintenance plans.

19) The system for asset and maintenance management, building management, and energy management of claim 17, wherein the management of work orders comprises receiving the work order, assigning personnel for execution, receiving them with the tasks performed for approval or disapproval.

20) The system for asset and maintenance management, building management, and energy management of claim 17, wherein the visualization of KPIs comprises automatically calculating KPIs per asset, per related group of assets, or per site.

21) The system for asset and maintenance management, building management, and energy management of claim 17, wherein the analysis of tasks, failures, and work orders comprises the analysis of assets or sites.

22) The system for asset and maintenance management, building management, and energy management of claim 17 allows the administration of assets in different locations.
